(19) United States
(12) Patent Application Publication
(10) Pub. No.: US 2021/0346733 A1
(43) Pub. Date: Nov. 11, 2021

(54) RESPIRATOR HAVING REPLACEABLE FILTRATION MEDIUM

(71) Applicant: Continuous Composites Inc., Coeur d'Alene, ID (US)

(72) Inventors: Nathan Andrew STRANBERG, Post Falls, ID (US); Andrew John OVERBY, Coeur d'Alene, ID (US)

(73) Assignee: Continuous Composites Inc., Coeur d'Alene, ID (US)

(21) Appl. No.: 17/301,172

(22) Filed: Mar. 29, 2021

Related U.S. Application Data
(60) Provisional application No. 63/020,192, filed on May 5, 2020.

(51) Int. Cl. A62B 23/02; A41D 13/11

(52) U.S. Cl. CPC A62B 23/02; A41D 13/11

(57) ABSTRACT

A respirator is disclosed for use in protecting a wearer from airborne contaminates. The respirator may include a body configured to seal against a face of a wearer and provide clearance for a nose, a mouth, and a chin of the wearer. The respirator may also include a frame connectable to the body. At least one of the body and the frame may be configured to receive and seal against a plurality of filter media having different shapes.

### RELATED APPLICATION

This application is based on and claims the benefit of priority from U.S. Provisional Application No. 63/020,192 that was filed on May 5, 2020, the contents of which are expressly incorporated herein by reference.

### TECHNICAL FIELD

The present disclosure relates generally to a respirator and, more particularly, to a respirator having replaceable filtration medium.

### BACKGROUND

Respirators are masks having filtration medium that inhibit inhalation of contaminated air by a wearer. The filtration medium is often provided in the form of a cartridge having a rigid housing that is removably connected to a facepiece. The cartridge can be connected to the facepiece via threaded fastening, clamping, or interference. Once the cartridge is saturated with contaminates or its usefulness otherwise exhausted, the cartridge is removed from the facepiece and disposed of and a new cartridge is mounted to the facepiece. An example of this type of respirator is disclosed in U.S. Pat. No. 5,505,197 that issued to Scholey on Apr. 9, 1996. Although acceptable for many applications, cartridge-type respirators can be expensive and prone to failure (e.g., cross-threading, unexpected disconnection, leakage, etc.).

An alternative respirator includes disposable filtration medium, which does not include a housing that is discarded after the usefulness of the filtration medium has been exhausted. Instead, the disposable filtration medium is attached to the facepiece of the respirator by way of a permanent housing that is integral to or removably attached to the facepiece. An example of this type of respirator is disclosed in U.S. Pat. No. 6,817,362 that issued to Gélinas et al. on Nov. 16, 2004. Although acceptable for some applications, these types of respirators can be complex (e.g., include many different parts that must be separately fabricated and assembled) and require uniquely shaped filtration medium that limit sourcing options.

The disclosed respirator is directed to overcoming one or more of the problems set forth above and/or other issues of the prior art.

### SUMMARY

In one aspect, the present disclosure is directed to a replaceable filter medium for a respirator. The replaceable filter medium may include a fabric having a teardrop shape. The replaceable filter medium may also include a plurality of pleats formed within the fabric.

In another aspect, the present disclosure is directed to a respirator. The respirator may include a body configured to seal against a face of a wearer and provide clearance for a nose, a mouth, and a chin of the wearer. The respirator may also include a frame connectable to the body. At least one of the body and the frame may be configured to receive and seal against a plurality of filter media having different shapes.

In yet another aspect, the present disclosure is directed to another respirator. This respirator may include a body having an annular membrane configured to provide clearance for a nose, a mouth, and a chin of a wearer, and an integral seal extending radially inward from the annular membrane to engage a face of a wearer. The respirator may also include a frame connectable to the body, and a filter medium connectable to at least one of the body and the frame. The respirator may include a plane of symmetry, and an edge of the body at an intersection of the annular membrane and the seal forms at least three curves at each opposing side of the plane of symmetry

### BRIEF DESCRIPTION OF THE DRAWINGS

FIG. 1 is an isometric view illustration of an exemplary disclosed respirator positioned on a wearer's face;

FIG. 2 is a side-elevation view illustration of the wearer and cross-sectional view of the exemplary disclosed respirator of FIG. 1;

FIG. 3 is an exploded view illustration of the exemplary disclosed respirator of FIGS. 1 and 2;

FIG. 4 is a reverse-elevation view illustration of the exemplary disclosed respirator of FIGS. 1-3;

FIG. 5 is a cross-sectional view illustration of the exemplary disclosed respirator of FIGS. 1-4;

FIG. 6 is a reverse-plan view illustration of the exemplary disclosed respirator of FIGS. 1-5;

FIG. 7 is a front-elevation view illustration of the exemplary disclosed respirator of FIGS. 1-6;

FIG. 8 is a side-elevation view illustration of the exemplary disclosed respirator of FIGS. 1-7;

FIG. 9 is an exploded view illustration of another exemplary disclosed respirator;

FIG. 10 is an isometric view illustration of the exemplary disclosed respirator of FIG. 9;

FIGS. 11 and 12 are cross-sectional view illustrations of the exemplary disclosed respirator of FIGS. 9 and 10;

FIGS. 13 and 14 are exploded view illustrations of another exemplary disclosed respirator; and

FIG. 15 is a cross-sectional illustration of the exemplary disclosed respirator of FIGS. 13 and 14.

### DETAILED DESCRIPTION

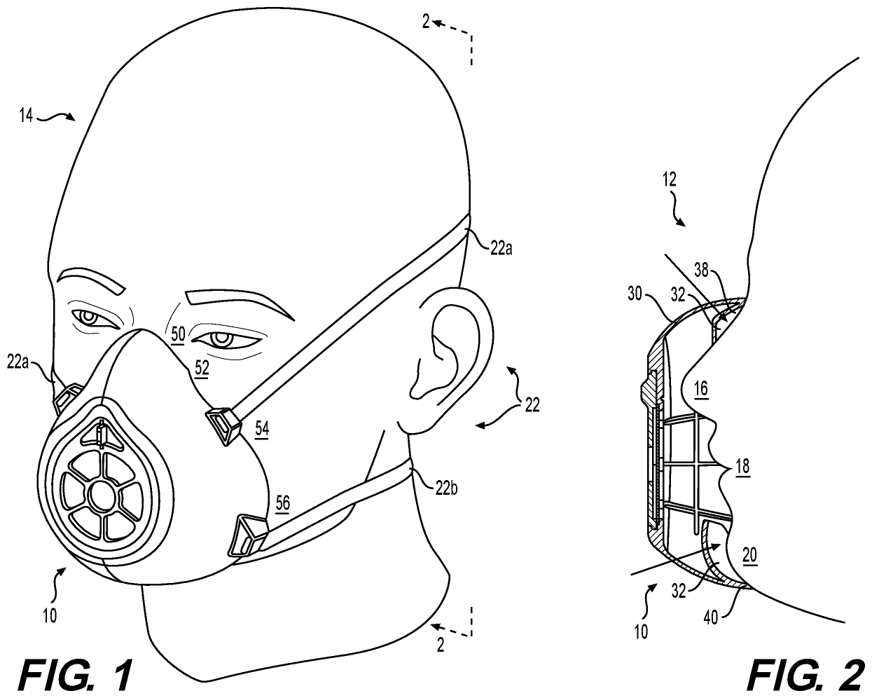

FIGS. 1 and 2 illustrate an exemplary disclosed respirator 10 positioned on a face 12 of a wearer 14. As shown in these figures, respirator 10 is configured to surround and enclose a nose 16, a mouth 18, and at least part (e.g., all) of a chin 20 of wearer 14. Respirator 10, when properly fitted to wearer 14, may seal against face 12, such that air inhaled and exhaled by wearer 14 passes primarily (e.g., only) through respirator 10. Respirator 10 may be held in place against face 12 by way of one or more straps 22. In the disclosed embodiment, an upper strap 22a may be connected to an upper or nose portion of respirator 10 and be configured to pass around wearer 14 at an above-ear location, and a lower strap 22b may be connected to a lower or mouth portion of respirator 10 and be configured to pass around wearer 14 at a below-ear or neck location.

It should be noted that, while straps 22 have been shown and described as encircling the head of wearer 14 during usage of respirator 10, it is contemplated that other configurations of straps 22 may be possible. For example, straps 22 could alternatively be configured to loop around the ears of wearer 14, without encircling the head. In another alternative embodiment, straps 22 could be provided with adhesive tabs that can be affixed to the cheeks or other areas of the wearer's head. It may also be possible to completely omit straps 22 and to configure respirator 10 to directly affix (e.g., via adhesive materials) to the wearer's face. Straps 22 have been omitted from FIG. 2 for purposes of clarity.

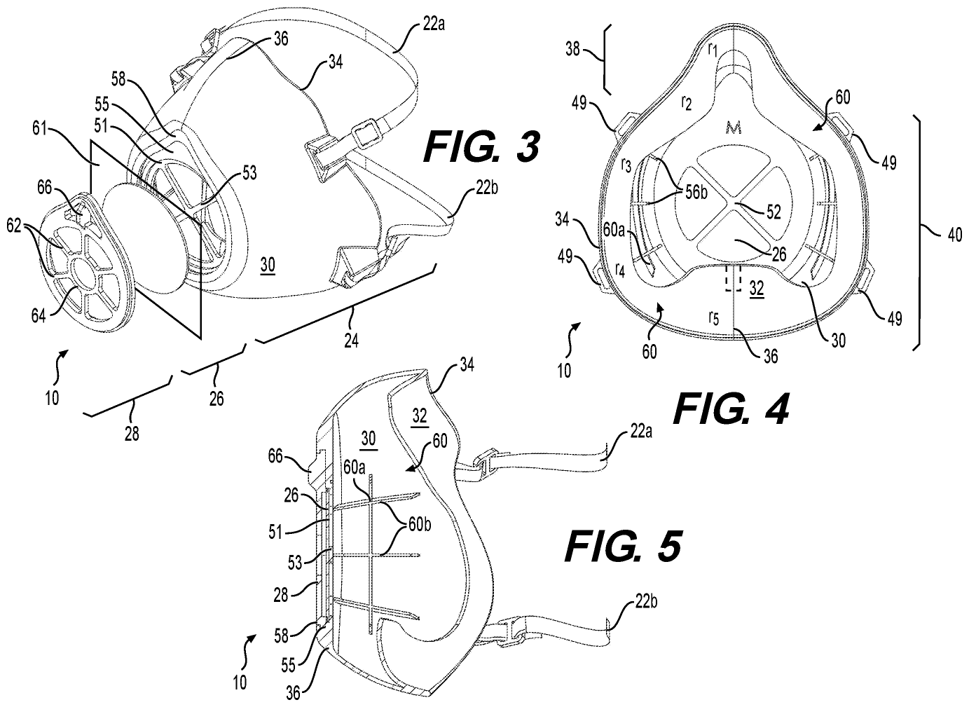

As shown in FIG. 3, respirator 10 may include a body 24 to which strap(s) 22 connect, a filter medium (“medium”) 26 that is removably received by body 24, and a frame 28 configured to provide structure to body 24 and/or retain medium 26 positioned relative to body 24. Strap(s) 22 may be connected to an end of body 24 proximal face 12 and opposite medium 26. Medium 26 may be sandwiched or otherwise trapped between body 24 and frame 28.

As can be seen in FIGS. 3-5, body 24 may generally be made up of an outer membrane (“membrane”) 30, and a seal 32 that skirts around a base or inner edge (“edge”) 34 of membrane 30 at the proximal end. In the disclosed embodiment, seal 32 is integral (e.g., fabricated) with membrane 30 (e.g., as a monolithic component) and extends laterally inward from edge 34 around an entire perimeter. In some embodiments, seal 32 may additionally extend from edge 34 toward the distal end (see, for example, FIG. 5). In the disclosed embodiments, seal and membrane 30 are fabricated from the same material. It is contemplated, however, that seal 32 could be fabricated separately from the same or different material and thereafter joined to membrane 30 (e.g., via interference fit, adhesive coupling, welding, etc.), if desired.

Body 24 may be uniquely shaped to fit a large range of face sizes, while still providing sealing. For example, body 24 may have a teardrop outer shape (see FIG. 4) that is symmetrical about a vertical plane 36. As shown in FIG. 2, a point 38 of the teardrop shape may be configured to receive nose 16, and a bulb 40 of the shape may be configured to receive mouth 18 and chin 20. When respirator 10 is placed on a smaller face 12 (shown in FIG. 2), seal 32 at point 38 of the teardrop shape may form a line of contact with a bridge of nose 16, while bulb 40 may form a line of contact with a lower or under portion of chin 20. When respirator 10 is placed on a larger face, respirator 10 may stretch in a vertical direction along plane 36, causing seal 32 to rotate toward face 12 (e.g., in the directions of the depicted arrows) and resulting in a greater or surface contact of seal 32 with nose 16 and chin 20.

A contour of edge 34 of body 24 may also facilitate improved sealing of seal 32 against face 12. As shown in FIGS. 1, 3, 5, and 8, edge 34 of body 24 may be complexly contoured to mirror a natural shape of face 12. For purposes of reference, edge 34 may curve in an X-direction (see FIG. 7) that is generally orthogonal to plane 36, either inward toward plane 36 or outward away from plane 36. In addition, edge 34 may curve in a Y-direction that is aligned with plane 36, either upward toward nose 16 or downward toward chin 20. Finally, edge 34 may additionally curve in a Z-direction that is generally aligned with plane 36, either rearward toward face 12 or forward away from face 12. Edge 34 may include any number of a complex curves that curve in multiple directions at the same time, concavely and/or convexly.

In the disclosed embodiment, edge 34 includes four complex curves 42, 44, 46, and 48 at each side of plane 36, each curve located further away from point 38 having a greater radius. For example, starting from plane 36 at point 38 of the teardrop shape, edge 34 may initially curve convexly outward away from plane 36 in the X-direction and downward in the Y-direction (see FIG. 7) to pass around the bridge of nose 16 (See FIG. 1), while also concavely curving rearward into face 12 in the Z-direction at a medial canthal region 50 (shown in FIG. 1) to form first complex curve 42. Starting from first complex curve 42, edge 34 may curve concavely outward away from plane 36 in the X-direction and downward in the Y-direction (see FIG. 7), while also convexly curving rearward into face 12 in the Z-direction at an infraorbital region 52 (shown in FIG. 1) to form second complex curve 44. Starting from second complex curve 44, edge 34 may curve convexly outward away from plane 36 in the X-direction and downward in the Y-direction (see FIG. 7), while also curving convexly rearward into face 12 in the Z-direction at a maxillary region 54 (shown in FIG. 1) to form third complex curve 46. Starting from third complex curve 44, edge 34 may curve convexly inward toward plane 36 in the X-direction and downward in the Y-direction (see FIG. 7), while also curving forward away from face 12 in the Z-direction at a mandibular area 56 (shown in FIG. 1) to form fourth complex curve 48.

Seal 32 may extend laterally a distance away from edge 34 that varies based on location around the perimeter of body 24 to further enhance sealing of respirator 10 to face 12 at the different regions discussed above. For example, as shown in FIG. 4, seal 32 may have a first radial dimension r₁ at first complex curve 42 (e.g., at medial canthal region 50), a second radial dimension r₂ at second complex curve 44 (e.g., at infraorbital region 52), a third radial dimension r₃ at third complex curve 46 (e.g., at maxillary region 54), a fourth radial dimension r₄ at fourth complex curve 48 (e.g., at mandibular area 56), and a fifth dimension r₅ at an intersection of seal 32 and plane 36 (e.g., at chin 20). In general, radial dimensions r₁, r₃, and r₄ may be about the same or a minimum dimension required for adequate sealing against face 12. Radial dimensions r₂ and r₅ may be larger (e.g., 1.25-5 times larger) than the other radial dimensions, with r₅ being larger than r₂ (e.g., 1.5-3 times larger). In some embodiments, seal 32 may be split at the r₅ (e.g., along plane 36—see dashed lines) to facilitate removal from a corresponding mold, if desired. It should be noted that, in some embodiments (e.g., the disclosed embodiment), seal 32 may be curved at locations adjacent curves 42-48 (e.g., minoring curves), which may enhance the sealing against face 12. In other embodiments, however, seal 32 may transition linearly between the radial dimensions (e.g., for purposes of simplicity).

Any number of mounting features 49 may be formed within membrane 30 to accommodate mounting of strap(s) 22. In the disclosed embodiment, four mounting features 49 are provided, and radially distributed at substantially equal angles around a periphery of membrane 30. For example, as shown in FIG. 4, mounting features 49 may be located at approximately 45° (e.g., 40-50°) relative to plane 36.

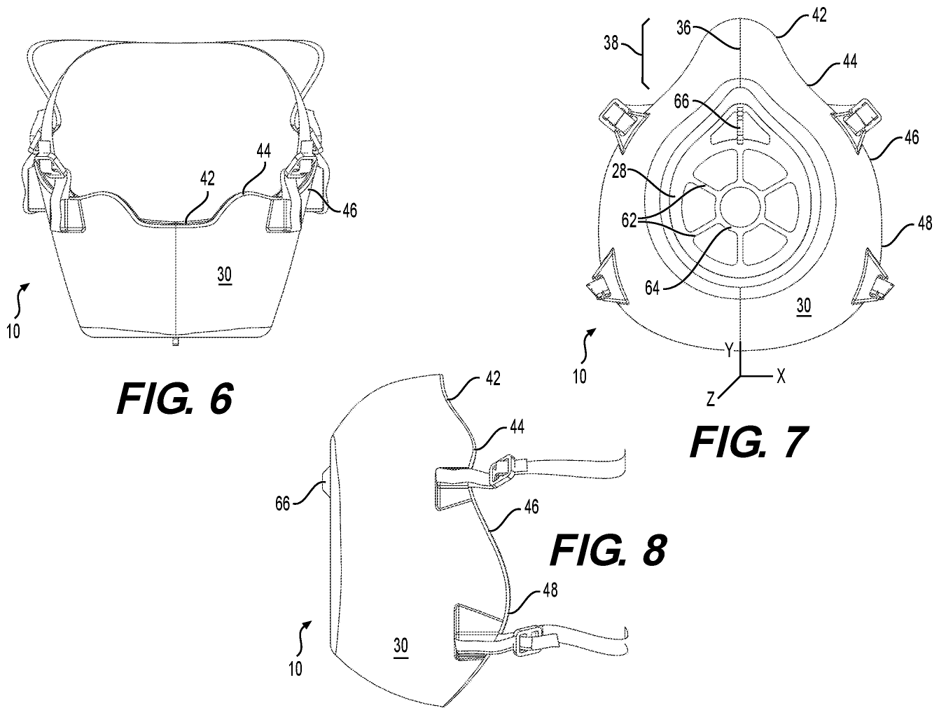

As shown in FIGS. 2, 6 and 8, membrane 30 of body 24 may protrude from the teardrop shaped edge 34 forward (e.g., away from face 12) in the Z-direction a distance required to provide internal clearance for nose 16. The protrusion of membrane 30 may result in a generally frustoconical shape (see FIG. 8), wherein membrane 30 tapers inward towards and is truncated at the end distal from face 12. As shown in FIGS. 3 and 5, a recess 51 may be formed within the distal end and configured to receive medium 26. Recess 51 may be generally cylindrical to match an outer shape of medium 26 and have a depth about equal (e.g., within engineering tolerances) to a thickness of medium 26. A perforated scaffold 53 may be integrally formed at an interior end of recess 51 to provide support for medium 26. In the disclosed embodiment, scaffold 53 may include one or more (e.g., two) crosspieces that extend from a periphery of recess 51 across an end of recess 51 (e.g., through a center axis of recess 51), leaving flow openings between the crosspieces. In one embodiment, the crosspieces of scaffold 53 may be generally aligned with mounting features 49 (e.g., within 0-15°).

As also shown in FIGS. 3 and 5, an additional recess 55 may be formed within the distal end of membrane 30 to receive frame 28. Recess 55 may have a teardrop shape that is similar to an outer shape of frame 28 and mirrors the general shape of respirator 10, and be located radially and axially outward from recess 51. A flange 58 may be formed within membrane 30 at an outer end of recess 55 and configured to extend radially inward over a periphery of frame 28, when frame 28 is fitted into recess 55. Flange 58 may function to retain frame 28 within recess 55.

Body 24, including membrane 30 and seal 32, may be fabricated from a flexible material (e.g., a polymer having a Shore-A of about (e.g., within engineering tolerances) 40-80, or about 45-55, and elongation at break of about 650-700%, or about 680%) that allows stretching in the vertical or Y-direction to accommodate the range of face sizes. While stretching in the vertical direction may be desirable to accommodate the range of face sizes, stretching in the horizontal or X-direction may need to be limited in order to maintain proper sealing. For this purpose, one or more ribs 60 may be formed at an interior surface of membrane 30, at the sides thereof (e.g., relative to the X-direction), to provide for stiffening that resists horizontal stretching. As shown in FIGS. 4 and 5, a single vertically oriented rib 60a may be included at each side of membrane 30 (e.g., relative to plane 36), with any number (e.g., three) horizonal ribs 60b spaced out along a length of rib 60a and intersecting rib 60a (e.g., at a general midpoint of ribs 60b). Ribs 60b may flare outwardly in the Y-direction from the distal end of membrane 30 towards edge 34 (e.g., at an angle of about 5-15°, within engineering tolerances).

A wall thickness of membrane 30 may be selected to provide a unique level of flexibility and structural integrity. In the disclosed embodiment, the wall thickness be about (e.g., within engineering tolerances) 1 mm (e.g., 1.0 mm±0.6 mm). A thicker wall may result in lower conformity to face 12, while a thinner wall may not have enough structural rigidity to hold the frustoconical shape and provide clearance for nose 16 and mouth 18. Body 24, in the disclosed embodiment, is injection molded and includes a part-line along plane 36. It is contemplated, however, that body 24 could be fabricated in another manner or have a different part line, if desired.

Body 24 may be configured to withstand sterilizing processes (e.g., autoclaving), without significant (e.g., detectable) deterioration. For example, the polymer used to make body 24 may be able to withstand sterilizing temperatures of about 150-175° F. (e.g., about 160° F.) that eliminate most contaminates encountered during use of respirator 10. This may allow body 24 to be reused with a new replacement medium 26, as will be explained in more detail below.

Medium 26 may include a fabric that is configured to fit into recess 51 and be retained and sealed by frame 28, while providing required protection from airborne contaminates in a low flow-restricted manner. In the disclosed embodiment, medium 26 is shaped as a circular disk having a density that can vary from about (e.g., within engineering tolerances) 25-50 g/m². Although a range of materials may be suitable for making medium 26, the disclosed medium 26 is fabricated from electrostatically charged spun-bound polypropylene. A flow resistance of medium 26 may be less than 25 mm H₂O. Medium 26 may have about (e.g., within engineering tolerances) 95% efficiency of blocking particles having a size of 0.3 microns or larger that are moving at about (e.g., within engineering tolerances) 85 L/min or slower. In one application a flow area of medium may be about (e.g., within engineering tolerances) 12-13 in² (e.g., 12.6 in²). In some applications, medium 26 may be infused with activated charcoal, if desired, to aid in neutralizing odors.

While only prefabricated disks of the disclosed filter medium 26 may be provided, recommended, and/or certified for use with respirator 10, it is understood that such disks may not always be immediately available when at least some protection from air-borne contaminates is required (e.g., during emergent and/or extended-use situations). In these situations, it may be possible to use one or more layers of an alternative emergency-only medium 61 sized and/or shaped from an alternative material that is immediately available to wearer 14. For example, any number of layers of cloth may be sized and/or shaped to completely cover recess 51 and to extend a distance past the periphery of frame 28, such that after insertion of frame 28 into recess 55, at least some of the cloth may be visible around an entire periphery of flange 58. The flexibility of flange 58 may allow for a range of material thicknesses, while still providing sealing.

Frame 28 may be configured to retain medium 26 in place inside of recess 51 of body 24. After medium 26 is placed into recess 51, frame 28 may be moved to overlap medium 26. Edges of frame 28 may then be pressed into a space formed by an end surface of recess 55 and flange 58. Flange 58 may flex out of the way of frame 28 during this installation, and return to its original position afterward to maintain frame 28 inside of the space and against medium 26. It is contemplated that medium 26 may be at least partially compressed at its periphery by frame 28 during and after installation, thereby providing a hermetic seal.

In addition to retaining medium inside of recess 51, frame 28 may additionally provide structure to body 24. For example, frame 28 may be fabricated from a higher-modulus polymer that is harder and stiffer (e.g., measurably harder and/or stiffer utilizing available engineering tools, for example about 10% or more harder and/or stiffer) than the polymer making up body 24 In one example, frame 28 may be fabricated from a polymer having a notched Izod impact rating at 73° F. of about (e.g., within engineering tolerances) 1.75-2.25 ft-lb/in, or 2 ft-lb/in. Like body 24, frame 28 may also be capable of withstanding sterilization temperatures for reuse with a replacement medium 26. However, it is contemplated that a used frame 28 could be replaced with a new frame 28 at the same time that medium 26 is replaced, if desired. Frame 28, also like body 24, may be fabricated from an injection molding process.

Frame 28 may take any shape that functions to structurally support body 24 at the distal end, holds medium 26 in place, and allows adequate airflow through medium 26. In the disclosed embodiment, frame 28 has a teardrop shape to mirror the overall shape of respirator 10 and compliment the shape of recess 55 into which frame 28 is received. As shown in FIGS. 3 and 7, frame 28 may additionally have an internal scaffold, with any number of radially oriented arms 62. In the depicted example, arms 62 extend from a centrally located ring 64 to a perimeter of frame 28. Ring 64, while providing a stronger center anchor for arms 62, could alternatively be replaced with an intersection point, if desired. Spacings between arms 62 and inside of ring 64 may provide channels for airflow. A handle 66 may be provided (e.g., at the point of the teardrop shape) to allow easier insertion and removal of frame 28 into and out of recess 55.

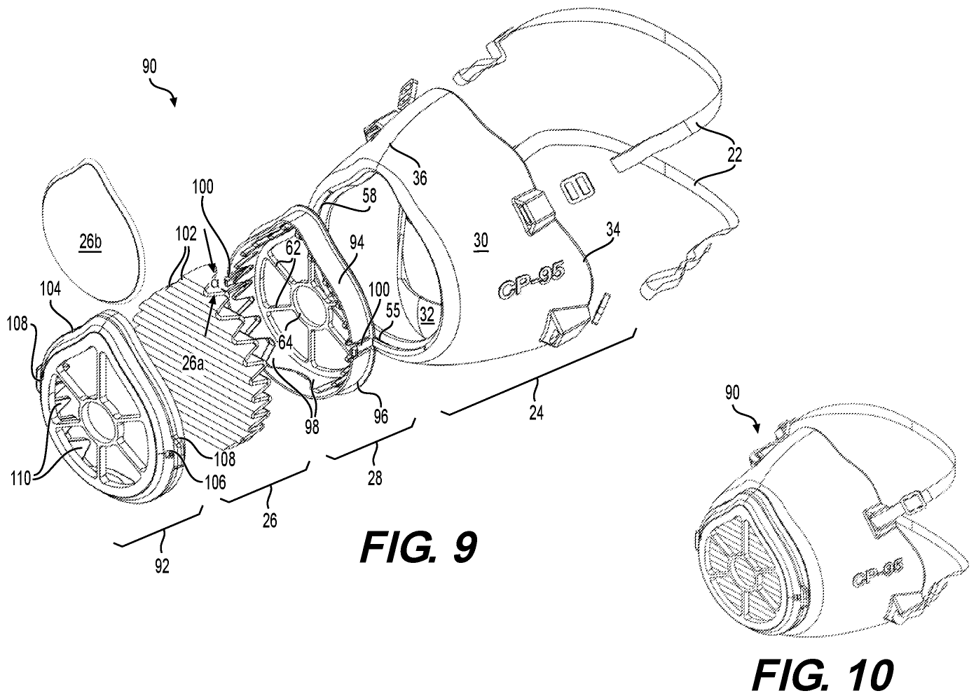

FIGS. 9, 10, 11, and 12 illustrate another exemplary respirator 90. Like respirator 10, respirator 90 may include straps 22, body 24, filtration medium 26, and frame 28. However, in contrast to respirator 10, frame 28 may be received first within recess 55 prior to installation of medium 26. In addition, an outer cover 92 may be configured to engage frame 28 (i.e., after installation of frame 28 into recess 55 of body 24) and sandwich medium 26 therebetween. For this reason, recess 51 may be omitted from body 24 and handle 66 may be omitted from frame 28.

As shown in FIG. 9, frame 28 may still have a teardrop shape with an internal scaffold having any number of radially oriented arms 62 extending from ring 64 to a perimeter. An annular wall 94 may extend axially outward in the Z-direction around an entire periphery of frame 28, and a rim 96 may extend radially outward from wall 94 for insertion into recess 55 below flange 58. Any number of undulations 98 extending in the Z-direction may be formed inward of wall 94 around the perimeter of frame 28 and function to seat and seal against an inner surface of medium 26. Undulations 98 may be symmetrically arranged relative to plane 36, with undulations 98 being generally narrower and closer together the farther they are away from plane 36. One or more fastening devices (e.g., compliant arms, hooks, latches, tabs, etc.) 100 may extend from body 24 toward cover 92 to facilitate secure connections therebetween.

As shown in FIG. 9, multiple different types of preformed media 26 may be useable with the disclosed embodiment of respirator 10. These types may include, for example, a longer term and/or higher-flow medium 26a and a shorter term and/or lower-flow medium 26b. Each of these media may have a teardrop outer shape that conforms to the inner shape of frame 28. Medium 26a may be pleated to increase a flow area thereof, while medium 26b may be generally planar. Any number of pleats 102 may be formed within medium 26a and be configured to overlay peaks of undulations 98. Although FIG. 9 shows pleats 102 extending lengthwise in the X-direction, other orientations are also contemplated. An angle α of pleats 102 that provides adequate airflow at a desired pressure within the confined space of respirator 10 may be about (within engineering tolerances) 25-35° (e.g., 30°). A smaller angle α may reduce manufacturability, while a greater angle α may require an increased depth of pleats 102 that could make respirator 90 bulky.

Cover 92 may have the same general teardrop shape as medium 26 and frame 28, and be configured to connect to frame 28. For example, cover 92 may have an internal scaffold that matches that of frame 28, and an outer skirt 104 that extends inward from the scaffold in the Z-direction to pass over and around wall 94 of frame 28. One or more fastening devices 106 may be formed within skirt 104 and configured to engage with and lock to fastening device(s) 100 of frame 28. Cover 92 may be fabricated from the same material as frame 28, such that it is stiffer than body 24, yet still flexible. One or more handles 108 may extend from cover 92 (e.g., radially outward from skirt 104) to aid in attachment to and/or removal from frame 28.

Like media 26, multiple different covers 92 may be useable with the disclosed embodiment of respirator 10. Each cover 92 may be specific to the type of media 26 that is installed into frame 28.

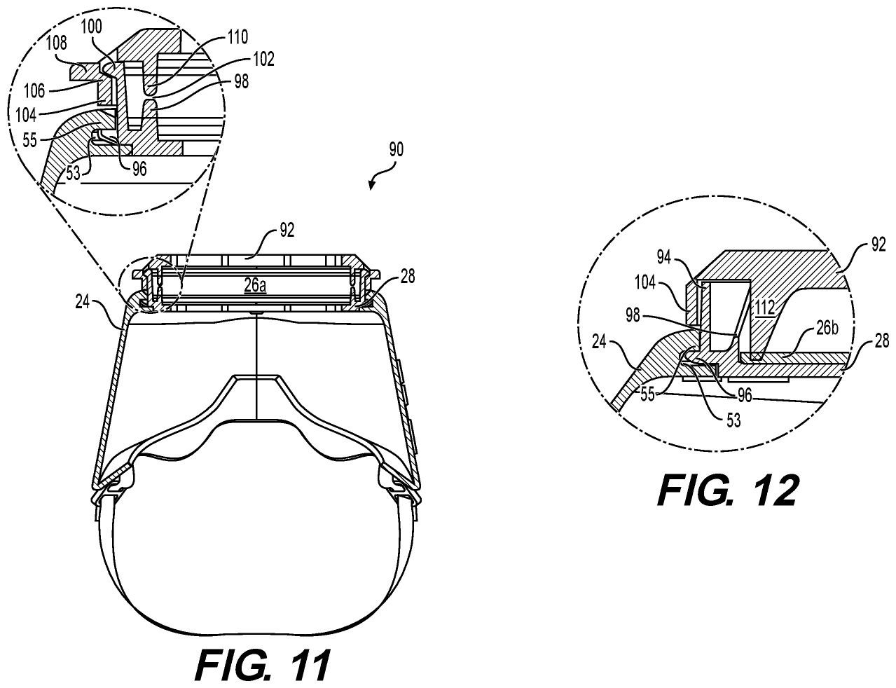

FIGS. 9 and 11 illustrate cover 92 as being configured for use with medium 26a. For example, cover 92 of FIG. 9 includes undulations 110 that are annularly offset (e.g., clocked) from and configured to intermesh with undulations 98 of frame 28. As shown in FIG. 11, a press-fit engagement may be formed between undulations 98 and 110, such that transverse edges of pleats 102 in medium 26a are pressed and sealed therebetween.

FIG. 12 illustrates cover 92 as being configured for use with medium 26b. For example, cover 92 of FIG. 12 has an inner skirt 112 instead of undulations 110. Inner skirt 112 may extend generally parallel to outer skirt 104, and extend a greater distance toward the scaffolding of frame 28. As shown in FIG. 12, a press-fit engagement may be formed between skirt 112 and a periphery of the scaffolding, such that an outer edge of medium 26b is pressed and sealed therebetween.

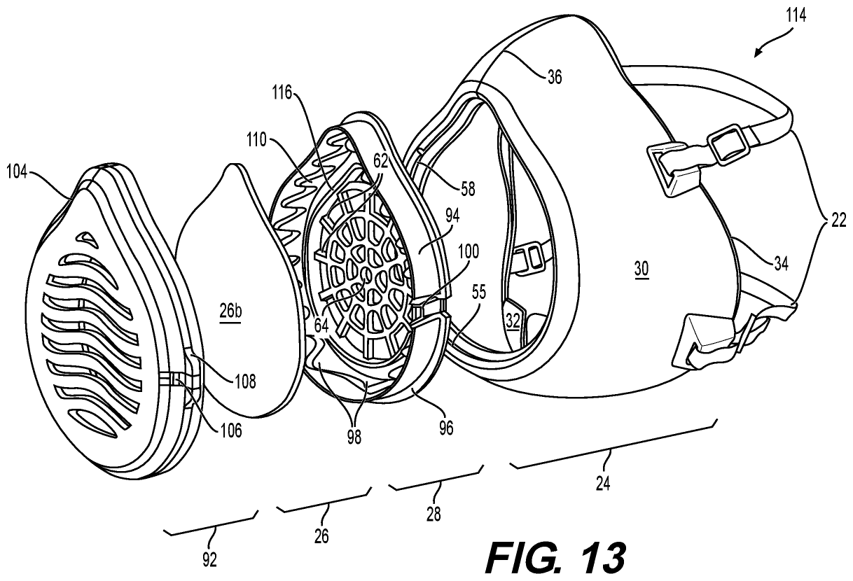

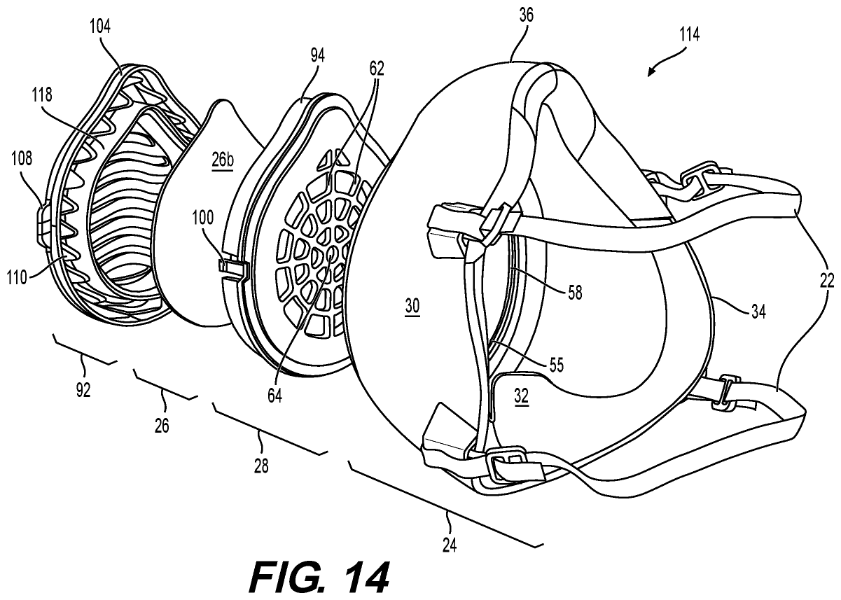

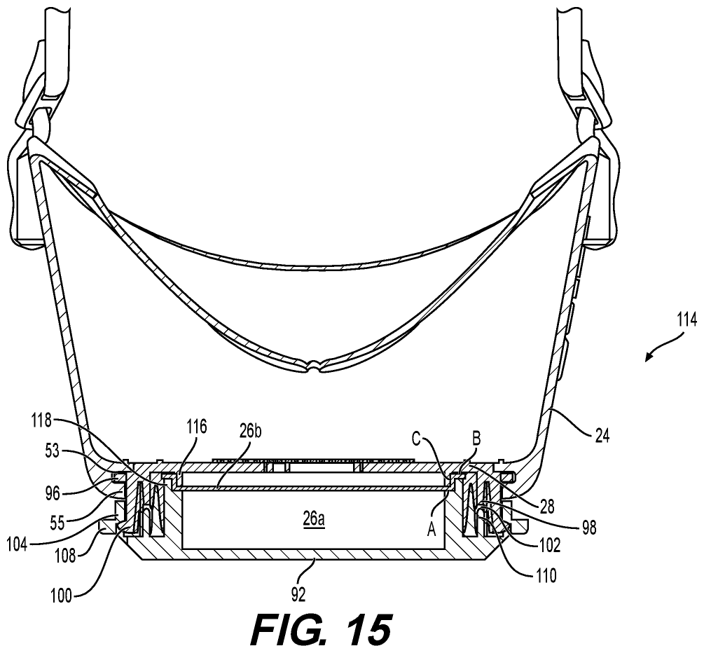

FIGS. 13-15 illustrate another exemplary respirator 114. Like respirators 10 and 90, respirator 114 may include straps 22, body 24, filtration medium 26, and frame 28. However, in contrast to respirator 10, features have been added to provide extra support for and sealing against medium 26. For example, each of frame 28 and cover 92 may arms 62 located closer together such that a greater number of smaller air channels are generated therebetween. This may inhibit penetration of the air channels by external objects that could cause undesired dislodgement of medium 26. In addition, the air channels formed within cover 92 may be different than the air channels formed within frame 28. For example, the air channels formed within cover 92 may be elongated slots extending primarily in the X-direction (e.g., horizontally, relative to the normal orientation during usage), while the air channels formed within frame 28 may be generally polygonal (e.g., truncated triangles or frustoconical shapes) and arranged radially around a center opening inside of ring 64. The mismatch of openings between cover 92 and frame 28 may make penetration even more difficult.

In addition, a rim 116 may be formed integrally with frame 28 at a location just outward of arms 62 and inward of undulations 98. Rim 116 may protrude toward cover 92 and have a general teardrop shape that matches the teardrop shape of media 26. A size of rim 116 may be smaller than a size of media 26, such that media 26 extend radially a distance past rim 116 around an entire perimeter. A similar rim 118 may be formed integrally with cover 92 and extend toward frame 28. Rim 118 may have a teardrop shape that is larger than the teardrop shape of frame 28 and smaller than the teardrop shape of media 26. With this configuration, rims 116 and 118 may together cause media to be folded through at least one (e.g., at least two) 90° bends and be sandwiched between frame 28 and cover 92 in multiple locations (e.g., at least two or at least three locations, labeled as A, B and C). In some embodiments, rim 118 may be stepped, such that the sandwiching occurs at two end face locations (A, B) and at one annular location (C). This arrangement may increase sealing of media 26.

### INDUSTRIAL APPLICABILITY

The disclosed respirator may be used to provide a wearer with air having reduced contaminates. The disclosed respirator may allow for the associated filtration medium to be easily replaced in a simple, reliable, and low-cost manner. Operation of the various embodiments of respirator 10 will now be explained.

Referring to the embodiment of FIGS. 1-8, prior to usage of respirator 10, medium 26 must be installed within recess 51. After placement of prefabricated medium 26 (or alternative emergency-only medium 61) into recess 51, frame 28 may be placed over medium 26 and edges thereof tucked under flange 58 and into recess 55. Respirator 10 may then be placed over nose 16, mouth 18, and chin 20 of wearer 14 and against face 12. Straps 22 may then be pulled over the head of wearer 14, with strap 22b being placed below the ear and strap 22a being placed above the ear.

After a period of time, medium 26 should be replaced with a new and clean medium 26. Frame 28 may be removed from respirator 10 by grasping and pulling handle 66 outwardly in the Z-direction. This action should generate sufficient force to pull the edges of frame 28 out from under flange 58. The flexibility of flange 58 may allow for this release without the use of tools. Medium 26 may then be plucked out of recess 51 and discarded. The remaining components of respirator 10 may then be sanitized (e.g., autoclaved, chemically scrubbed, exposed to ultraviolet light, etc.). Thereafter, a new medium 26 may be reinstalled, making respirator 10 ready for reuse. It is contemplated that medium 26 may be replaced multiple times between sanitation events, in some circumstances. It should be noted that a time between replacements may be dependent on characteristics of wearer 14 and the environment in which wearer 14 is operating.

Respirator 90 of FIGS. 9-12 may be utilized in a similar manner. However, in contrast to the above-described operations, frame 28 may remain in place during replacements of medium 26. Instead, cover 92 may be removed and reinstalled in connection with medium replacements. It should be noted that frame 28 may be used interchangeably with media 26a and 26b, but care should be taken to install the particular cover 92 corresponding to the installed medium. To remove cover 92, handle(s) 108 may be pulled outward in the Z-direction, releasing fastening device(s) 100 from fastening device(s) 106 located at the transverse sides of respirator 90.

The flexibility of fastening device(s) 100 may allow for this release without the use of tools. For example, as shown in FIG. 11, a distal end of fastening device 100 may have a tapered mating surface that engages a similar tapered mating surface of fastening device 106. As handle 108 is pulled away from frame 28, the tapered mating surfaces may cause the distal end of fastening device 100 to slide radially inward and away from each fastening device 106, until disengagement is achieved

Because medium 26 may be the only disposable part of respirators 10 and 90 and the remainder of respirators 10 and 90 may be sanitized, an operating cost of respirators 10 and 90 may be low. Likewise, because the only disposable part of respirators 10 and 90 may be small and simple, the cost of replacement mediums 26 may be low. In addition, a shape of respirators 10 and 90 may facilitate sealing against a wide range of face sizes with enhanced comfort. Respirators 10 and 90 may also be simple to fabricate, thereby lowering their initial costs, and simple to use. Finally, although not as efficient at blocking harmful contaminates, the alternative emergency-only medium 61 may allow for at least some protection when replacement mediums 26 are unavailable.

It will be apparent to those skilled in the art that various modifications and variations can be made to the disclosed respirators. Other embodiments will be apparent to those skilled in the art from consideration of the specification and practice of the disclosed respirators. It is intended that the specification and examples be considered as exemplary only, with a true scope being indicated by the following claims and their equivalents.

What is claimed is:

1. A replaceable filter medium for a respirator, comprising:
a fabric having a teardrop shape; and
a plurality of pleats formed within the fabric.

2. The replaceable filter medium of claim 1, wherein each of the plurality of pleats has an angle between adjacent internal surfaces of about 25-35°.

3. The replaceable filter medium of claim 1, wherein:
the teardrop shape has a center plane of symmetry; and
the plurality of pleats extends transversely across the center plane of symmetry.

4. The replaceable filter medium of claim 1, wherein the fabric has a density of about 25-50 g/m².

5. The replaceable filter medium of claim 1, wherein the fabric has a flow resistance less than about 25 mm H₂O.

6. The replaceable filter medium of claim 1, wherein the fabric has an efficiency of about 95% of blocking particles having a size of about 0.3 microns or larger that are moving at about 85 L/min or slower.

7. The replaceable filter medium of claim 1, wherein the fabric has a flow area of about 12-13 in².

8. A respirator, comprising:
a body configured to seal against a face of a wearer and provide internal clearance for a nose, a mouth, and a chin of the wearer; and
a frame removably connectable to the body,
wherein at least one of the body and the frame is configured to receive and seal against a plurality of filter media having different shapes.

9. The respirator of claim 8, wherein the frame is at least one of harder and stiffer than the body.

10. The respirator of claim 9, wherein the body includes:
an annular membrane; and
a seal that extends radially inward and axially outward from a periphery of the annular membrane to engage the face of the wearer.

11. The respirator of claim 10, wherein:
the annular membrane is configured to stretch in a first direction from a line-contact position of the seal with the wearer's face to a surface-contact position of the seal with the wearer's face; and
the respirator includes a plurality of ribs located at transverse sides of the frame to inhibit the annular membrane from stretching in a second direction orthogonal to the first direction.

12. The respirator of claim 11, wherein:
the body is frustoconical, having a base end and a distal end; and
at least one recess is formed in the distal end to receive at least one of the plurality of filter media and the frame.

13. The respirator of claim 12, wherein the at least one recess includes:
a first recess configured to receive the plurality of filter media; and
a second recess configured to receive the frame.

14. The respirator of claim 8, wherein:
the body includes a recess configured to receive the frame;
the frame includes a recess configured to receive the plurality of filter media; and
the respirator further includes at least one cover configured to engage the frame and compress the plurality of filter media.

15. The respirator of claim 14, wherein:
the at least one cover includes a first engagement feature configured to engage only a first of the plurality of filter media having a first shape; and
the at least one cover includes a second engagement feature different from the first engagement feature and configured to engage only a second of the plurality of filter media having a second shape.

16. The respirator of claim 15, wherein the at least one cover includes:
a first cover configured for use only with the first of the plurality of filter media; and
a second cover configured for use only with the second of the plurality of filter media.

17. The respirator of claim 16, wherein:
the first of the plurality of filter media is planar;
the second of the plurality of filter media is pleated, and
each of the first and second of the plurality of differently shaped filter media have a teardrop outline.

18. The respirator of claim 14, wherein engagement of the at least one cover with the body causes at least one of the plurality of filer media to fold.

19. The respirator of claim 18, wherein the engagement causes the at least one of the plurality of filer media to fold in at least two locations.

20. The respirator of claim 14, wherein engagement of the at least one cover with the body causes the at least one of the plurality of filer media to be sandwiched between end-faces and between annular surfaces of the at least one cover and the body.

21. The respirator of claim 14, wherein:
the cover includes a plurality of openings to pass air;
the body includes a plurality of openings to pass air; and
the plurality of openings in the cover are misaligned with the plurality of openings in the body.

22. A respirator, comprising:
a body having an annular membrane configured to provide clearance for a nose, a mouth, and a chin of a wearer, and an integral seal extending radially inward from the annular membrane to engage a face of a wearer;
a frame connectable to the body; and
a filter medium connectable to at least one of the body and the frame,
wherein:
the respirator includes a plane of symmetry; and
an edge of the body at an intersection of the annular membrane and the seal forms at least three curves at each opposing side of the plane of symmetry.

23. The respirator of claim 22, wherein:
the respirator includes an X-direction that extends orthogonally to the plane of symmetry, a Y-direction that extends parallel with the plane of symmetry and a line extending between a nose and a chin portion of the respirator and orthogonally to the X-direction, and a Z-direction that extends parallel with the plane of symmetry and orthogonally to the X- and Y-directions; and
the at least three curves includes:
a first complex curve that extends convexly outward away from the plane of symmetry in the X-direction and downward from a nose of the wearer toward a chin in the Y-direction to pass around a bridge of the nose, while also extending concavely rearward in the Z-direction toward the wearer at a medial canthal region; and
a second curve that starts from an end of the first complex curve and extends concavely outward away from the plane of symmetry in the X-direction and downward in the Y-direction while also convexly curving rearward the Z-direction at an infraorbital region.

24. The respirator of claim 23, wherein the at least three curves further includes:
a third complex curve that starts from an end of the second complex curve and extends convexly outward away from the plane of symmetry in the X-direction and downward in the Y-direction, while also extending convexly rearward in the Z-direction at a maxillary region; and
a fourth complex curve that starts from an end of the third complex curve and extends convexly inward toward the plane of symmetry in the X-direction and downward in the Y-direction, while also extending forward in the Z-direction at a mandibular area.
